(19) United States
(12) Patent Application Publication
(10) Pub. No.: US 2024/0159254 A1
(43) Pub. Date: May 16, 2024

(54) Systems and Methods for Pressure Control

(71) Applicant: HUSCO International, Inc., Waukesha, WI (US)

(72) Inventors: Tom Peterson, New Berlin, WI (US); Andrew Kundert, Black River Falls, WI (US); Casey Buschkopf, Brookfield, WI (US); Eric Hamkins, Waukesha, WI (US); Ben Holter, New Berlin, WI (US); Corey K. Quinnell, West Allis, WI (US)

(21) Appl. No.: 18/284,256

(22) PCT Filed: Mar. 28, 2022
(86) PCT No.: PCT/US2022/022203

§ 371 Date: Sep. 26, 2023

Related U.S. Application Data
(60) Provisional application No. 63/166,845, filed on Mar. 26, 2021.

(51) Int. Cl. F15B 13/04; F15B 13/043

(52) U.S. Cl. CPC F15B 13/0405; F15B 13/0433; F15B 2211/329

(57) ABSTRACT

A hydraulic system includes a poppet control valve having an inlet workport, a function workport, a control chamber, and a poppet arranged between the inlet workport and the control chamber. The poppet is movable between an open position and a closed position. The hydraulic system further includes a pilot control valve. A pressure correlated to the function workport is supplied to a first side of the pilot control valve and a pilot source pressure is supplied to a second side of the pilot control valve. When a pressure in the function workport reaches a setpoint pressure, the pressure correlated to the function workport forces the pilot control valve to a position that increases a flow restriction between the control chamber and the function workport, so that the poppet moves in a direction toward the closed position and limits the pressure in the function workport to the setpoint pressure.

### CROSS-REFERENCES TO RELATED APPLICATIONS

The present application is based on and claims priority to U.S. Provisional Patent Application No. 63/166,845, filed on Mar. 26, 2021, which is incorporated herein by reference in its entirety.

### STATEMENT REGARDING FEDERALLY SPONSORED RESEARCH

Not Applicable.

### BACKGROUND

Off-highway machines/vehicles commonly include one or more functions that may be hydraulically controlled.

### BRIEF SUMMARY

The present disclosure provides hydraulic systems and methods for pressure control of a function workport. For example, fluid flow to a function workport may be limited by forcing a pilot control valve to move toward a closed position in response to the function workport pressure increasing beyond a setpoint pressure. Unlike conventional hydraulic systems that dump excess workport flow to a hydraulic reservoir, e.g., a tank, the hydraulic systems disclosed herein regulate workport pressure without dumping excess flow to tank, which improves hydraulic efficiency and improves system performance (e.g., the pressure/flow that is not dumped to tank can be utilized by other functions).

In one aspect, the present disclosure provides a hydraulic system for controlling a flow of fluid to a function. The hydraulic system includes a poppet control valve including an inlet workport, a function workport, a control chamber, and a poppet arranged between the inlet workport and the control chamber. The poppet is movable between an open position and a closed position. The hydraulic system further includes a pilot control valve. A pressure correlated to the function workport is supplied to a first side of the pilot control valve and a pilot source pressure is supplied to a second side of the pilot control valve. When a pressure in the function workport reaches a setpoint pressure, the pressure correlated to the function workport forces the pilot control valve to a position that increases a flow restriction between the control chamber and the function workport, so that the poppet moves in a direction toward the closed position and limits the pressure in the function workport to the setpoint pressure.

In one aspect, the present disclosure provides a hydraulic system for controlling a flow of fluid to a function. The hydraulic system includes a poppet control valve having an inlet workport, a function workport, a control chamber, and a poppet arranged between the inlet workport and the control chamber. The poppet includes a variable orifice that defines an increasing flow area in the control chamber as the poppet moves from a closed position toward an open position. The hydraulic system further includes a pilot control valve arranged between the control chamber and the function workport. A pusher rod is in engagement with a first side of the pilot control valve and a pilot source pressure is supplied to a second side of the pilot control valve. The hydraulic system further includes a relief valve arranged downstream of the function workport and a sense orifice arranged downstream of the relief valve. A sense pressure between the relief valve and the sense orifice is supplied to the pusher rod. When a pressure in the function workport reaches a setpoint pressure, the relief valve is configured to move from a relief valve closed position to a relief valve open position, so that the sense pressure increases and forces the pusher rod to move the pilot control valve toward a pilot valve closed position and the poppet moves in a direction toward the closed position to limit the pressure in the function workport to the setpoint pressure.

In one aspect, the present disclosure provides a hydraulic system for controlling a flow of fluid to a function. The hydraulic system includes a poppet control valve having an inlet workport, a function workport, a control chamber, and a poppet arranged between the inlet workport and the control chamber. The poppet includes a variable orifice that defines an increasing flow area in the control chamber as the poppet moves from a closed position toward an open position. The hydraulic system further includes a first pilot control valve arranged between the control chamber and the function workport and a second pilot control valve arranged in series with the first pilot control valve. A spring is in engagement with a first side of the second pilot control valve and a pilot source pressure is supplied to a second side of the second pilot control valve. When a pressure in the function workport reaches a setpoint pressure, the first pilot control valve is configured to move toward a first pilot valve closed position to increase a restriction between the control chamber and the function workport, so that the poppet moves in a direction toward the closed position and limits the pressure in the function workport to the setpoint pressure.

The foregoing and other aspects and advantages of the disclosure will appear from the following description. In the description, reference is made to the accompanying drawings which form a part hereof, and in which there is shown by way of illustration a preferred configuration of the disclosure. Such configuration does not necessarily represent the full scope of the disclosure, however, and reference is made therefore to the claims and herein for interpreting the scope of the disclosure.

### BRIEF DESCRIPTION OF DRAWINGS

The invention will be better understood and features, aspects and advantages other than those set forth above will become apparent when consideration is given to the following detailed description thereof. Such detailed description makes reference to the following drawings.

FIG. 1 is a schematic illustration of a hydraulic system including a relief valve according to aspects of the present disclosure.

FIG. 2 is a schematic illustration of the hydraulic system of FIG. 1 including two pumps and two poppet control valves.

FIG. 3 is a schematic illustration of a hydraulic system including a first pilot control valve and a second pilot control valve according to aspects of the present disclosure.

FIG. 4 is a schematic illustration of the hydraulic system of FIG. 3 with a first pilot control valve being configured to restrict flow to a single workport from two pumps.

FIG. 5 is a schematic illustration of a hydraulic system including a first pilot control valve, a second pilot control valve, and a relief valve.

FIG. 6 is a schematic illustration of the hydraulic system of FIG. 5 including two pumps and two poppet control valves.

FIG. 7 is a schematic illustration of a hydraulic system including an area-balanced control valve according to aspects of the present disclosure.

### DETAILED DESCRIPTION

Before any aspect of the present disclosure are explained in detail, it is to be understood that the present disclosure is not limited in its application to the details of construction and the arrangement of components set forth in the following description or illustrated in the following drawings. The present disclosure is capable of other configurations and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use aspects of the present disclosure. Various modifications to the illustrated configurations will be readily apparent to those skilled in the art, and the generic principles herein can be applied to other configurations and applications without departing from aspects of the present disclosure. Thus, aspects of the present disclosure are not intended to be limited to configurations shown, but are to be accorded the widest scope consistent with the principles and features disclosed herein. The following detailed description is to be read with reference to the figures, in which like elements in different figures have like reference numerals. The figures, which are not necessarily to scale, depict selected configurations and are not intended to limit the scope of the present disclosure. Skilled artisans will recognize the non-limiting examples provided herein have many useful alternatives and fall within the scope of the present disclosure.

The use of the terms “downstream” and “upstream” herein are terms that indicate direction relative to the flow of a fluid. The term “downstream” corresponds to the direction of fluid flow, while the term “upstream” refers to the direction opposite or against the direction of fluid flow.

Generally, the present disclosure provides hydraulic pressure control that regulates a function workport pressure by limiting flow to the function workport via one or more hydraulic components. For example, the hydraulic components can include one or more of a relief valve, an orifice, a spool, a poppet, or a control valve. In general, movement of at least one of the hydraulic components may be correlated to a pressure in the function workport, so that when the pressure in the function workport reaches a setpoint pressure, the hydraulic components may close down a poppet control valve (i.e., a poppet may move toward a closed position) that supplies fluid flow to the function, which increases restriction and limits fluid flow to the function, and limits the pressure in the function workport to the setpoint pressure.

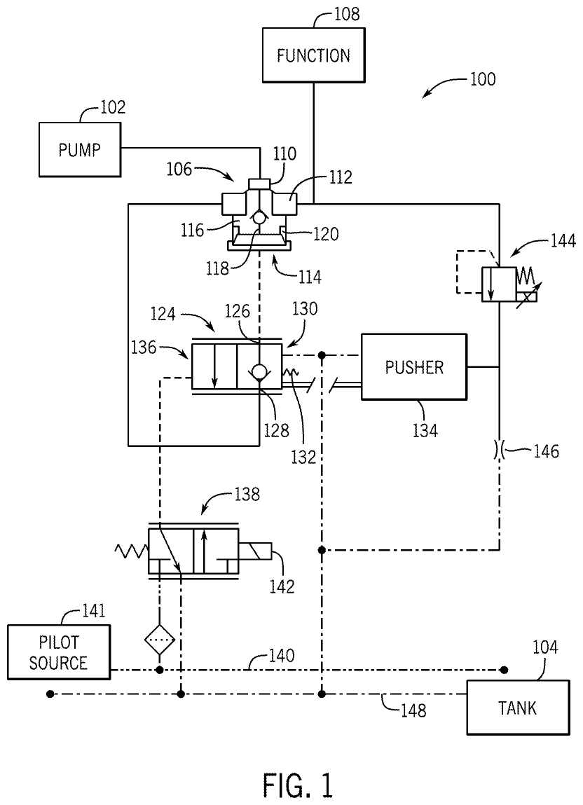

FIG. 1 illustrates one non-limiting example of a hydraulic system 100 according to aspects of the present disclosure. The hydraulic system 100 includes a pump 102 that is configured to furnish a working fluid (e.g., oil) from a tank or reservoir 104 under increased pressure to a poppet control valve 106 arranged downstream of the pump 102. The poppet control valve 106 is configured to control a flow a fluid to one or more functions 108. The function 108 can be any component on an off-highway vehicle/machine that is hydraulically controlled (e.g., an actuator, a bucket, a motor, a mast, etc.). In the illustrated non-limiting example, the hydraulic system 100 includes a single poppet control valve 106 controlling fluid flow to the function 108, but other configurations are possible. For example, the poppet control valve 106 can control fluid flow to a plurality of functions (e.g., two or more function), or a plurality of poppet control valves 106 can control fluid flow to a single function.

In the illustrated non-limiting example, the poppet control valve 106 includes an inlet workport 110, a function workport 112, a control chamber 114, and a poppet 116 arranged between the inlet workport 110 and the control chamber 114. The inlet workport 110 is in fluid communication with the pump 102, and the function workport 112 is in fluid communication with the function 108. The poppet 116 includes a control passage 118 and a variable orifice 120. The control passage 118 extends through the poppet 116 and provides fluid communication between the inlet workport 110 and the control chamber 114 through the variable orifice 120. The variable orifice 120 defines an increasing flow area along the control passage 118 as the poppet 116 moves from a closed position toward an open position. In the illustrated non-limiting example, the variable orifice 120 is formed by notches that extend into an end of the poppet 116 adjacent to the control chamber 114. The notches are configured so that the flow area defined by the variable orifice 120 increases as the poppet 116 moves from the open position toward the closed position (e.g., downward from the perspective of FIG. 1).

In general, the poppet control valve 106 is configured to supply fluid flow to the function 108. For example, fluid from the pump 102 may be supplied to the inlet workport 110 and the pressure at the inlet workport 110 may increase to force the poppet 116 from the closed position, where fluid flow is inhibited between the inlet workport 110 and the function workport 112, to the open position where fluid flow is allowed between the inlet workport 110 and the function workport 112. The position of the poppet 116 (e.g., how far away from the closed position the poppet 116 opens) and the corresponding flow restriction between the inlet workport 110 and the function workport 112 is dependent on the position of a pilot control valve 124 and the pressures at the function workport 112 and the control chamber 114.

In the illustrated non-limiting example, the pilot control valve 124 is arranged between the control chamber 114 and the function workport 112. In some non-limiting examples, the pilot control valve 124 may include a poppet or a spool that is movable between any number of positions (e.g., movable in proportion to the forces supplied to each end of the spool or poppet) to vary a restriction between the control chamber 114 and the function workport 112 and control the amount of fluid flow supplied from the inlet workport 110 to the function workport 112. In the illustrated non-limiting example, the pilot control valve 124 includes a first pilot port 126 in fluid communication with the control chamber 114 and a second pilot port 128 in fluid communication with the function workport 112. A first side 130 of the pilot control valve 124 is supplied with a pressure correlated to the function workport 112 and is biased by a spring 132. In the illustrated non-limiting example, the pressure correlated to the function workport 112 is supplied to the first side 130 of the pilot control valve 124 by a pusher rod 134 in engagement with the first side 130 of the pilot control valve 124.

A second side 136 of the pilot control valve 124 is supplied with a pilot source pressure. In the illustrated non-limiting example, the pilot source pressure is provided to the second side of the pilot control valve 124 by a pilot source control valve 138. The pilot source control valve 138 is configured to selectively supply the pilot source pressure from a pilot conduit 140, which is connected to a pilot source 141, to the second side of the pilot control valve 124, for example, via selective actuation of a solenoid 142 coupled to the pilot source control valve 138. In some non-limiting examples, the pilot source 141 may be supplied from the pump 102. In other non-limiting examples, the pilot source 141 may be supplied from a different pump or another fluid pressure source.

In the illustrated non-limiting example, the hydraulic system 100 includes a relief valve 144 arranged downstream of and in fluid communication with the function workport 112. The relief valve 144 is configured to move from a relief valve closed position, where fluid communication is inhibited from the function workport 112 past the relief valve 144, to a relief valve open position, where fluid communication is allowed from the function workport 112 past the relief valve 144. In general, the relief valve 144 is configured to move from the relief valve closed position to the relief valve open position when the pressure in the function workport 112 reaches a setpoint pressure. In the illustrated non-limiting example, the relief valve 144 is an electrohydraulic relief valve with an adjustable-force solenoid (e.g., a proportional solenoid) biasing the relief valve 144 and configured to selectively adjust the setpoint pressure. In some non-limiting examples, the relief valve 144 may include a manually-adjustable setpoint pressure (e.g., an adjustable spring) controlling movement of the relief valve 144 from the relief valve closed position to the relief valve open position.

A sense orifice 146 is arranged downstream of the relief valve 144. An upstream-side of the sense orifice 146 is in fluid communication with the relief valve 144 and a downstream-side of the sense orifice 146 is in fluid communication with a return conduit 148. The return conduit 148 is in fluid communication with the tank 104. In the illustrated non-limiting example, the sense orifice 146 is a fixed orifice.

In operation, the pump 102 supplies fluid flow to the inlet workport 110 of the poppet control valve 106 and the pilot source control valve 138 opens to supply the pilot source pressure to the second side 136 of the pilot control valve 124. The pressure in the inlet workport 110 increases and moves the poppet 116 from the closed position to the open position where fluid flow is provided to the function workport 112 and to the function 108. The pilot source pressure supplied to the second side 136 of the pilot control valve 124 forces the pilot control valve 124 toward a pilot valve open position where fluid communication is provided between the control chamber 114 and the function workport 112. With the control passage 118 providing fluid communication between the inlet workport 110 (and the function workport 112 when the poppet 116 is in the open position) and the control chamber 114, and the pilot control valve 124 allowing fluid communication between the control chamber 114 and the function workport 112, the poppet 116 will move to an open position where the poppet 116 is pressure balanced. That is, the poppet 116 will move to an open position where the forces on both sides of the poppet 116 (i.e., pressure times area) are balanced.

In general, the position of the pilot control valve 124 between the pilot valve open position (e.g., valve moves to the right from the perspective of FIG. 1) and a pilot valve closed position (e.g., valve moves to the left from the perspective of FIG. 1) controls a restriction between the control chamber 114 and the function workport 112, which influences a position of the poppet 116 between the open position and the closed position and can control an amount of fluid flow supplied to the function 108. During operation of the hydraulic system 100, the pressure at the function workport 112 may fluctuate due to one or more factors (e.g., high function load, pump pressure, initial command to the pilot control valve 124, etc.). If the pressure in the function workport 112 reaches the setpoint pressure of the relief valve 144, the relief valve 144 will move from the relief valve closed position to the relief valve open position and fluid flow is provided through the sense orifice 146. The fluid flow through the sense orifice 146 increases a pressure between the relief valve 144 and the sense orifice 146. In the illustrated non-limiting example, the pressure correlated to the function workport 112 supplied to the first side 130 of the pilot control valve 124 is located between the relief valve 144 and the sense orifice 146 (i.e., a sense pressure). Specifically, the sense pressure located between the relief valve 144 and the sense orifice 146 is supplied to the pusher rod 134, which engages the first side 130 of the pilot control valve 124. In some non-limiting examples, an area defined by a side of the pusher rod 134 supplied with the sense pressure is larger than an area of the second side 136 of the pilot control valve 124 supplied with the pilot source pressure. In this way, for example, the pilot control valve 124 can be forced toward the closed position with a sense pressure that is less than the pilot source pressure, which reduces the pressure requirements for the pilot control valve 124.

In general, the increasing sense pressure located between the relief valve 144 and the sense orifice 146 forces the pilot control valve 124 to a position that increases a flow restriction between the control chamber 114 and the function workport 112. In the illustrated non-limiting example, the sense pressure between the relief valve 144 and the sense orifice 146 acts on the pusher rod 134, which forces the pilot control valve 124 toward the pilot valve closed position and increases the restriction in the flow path between the control chamber 114 and the function workport 112. The increased restriction between the control chamber 114 and the function workport 112 increases the pressure in the control chamber 114 and forces the poppet 116 to move in a direction toward the closed position. Moving the poppet 116 toward the closed position limits fluid flow to the function 108 thereby limiting the pressure in the function workport 112. In this way, for example, the sense pressure acting on the pilot control valve 124 acts to limit the pressure in the function workport 112 to the setpoint pressure. That is, the sense pressure is correlated to the function workport 112 so that when the workport pressure reaches the setpoint pressure, it is detected by the sense pressure and acts on the pilot control valve 124 to limit the workport pressure to the setpoint pressure, and prevent the workport pressure from exceeding the setpoint pressure.

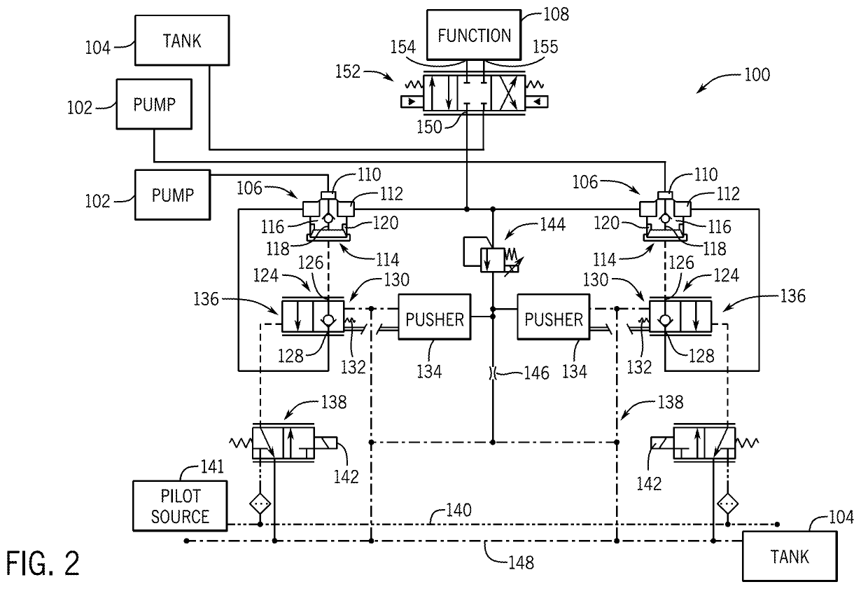

The workport pressure control functionality provided by the hydraulic system 100 may be expanded to accommodate various pump, workport, poppet control valve, and function configurations. For example, FIG. 2 illustrates the hydraulic system 100 including two poppet control valves 106 supplying fluid flow to an inlet port 150 on a directional control valve 152. The directional control valve 152 is configured to selectively move and supply one function port 154 with pressure from the inlet port 150 and connect another function port 155 to the tank 104. Both of the pilot control valves 124 are supplied with the sense pressure between the relief valve 144 and the sense orifice 146, which limits the pressure in upstream of the directional valve 154 to the setpoint pressure as described above with respect to FIG. 1.

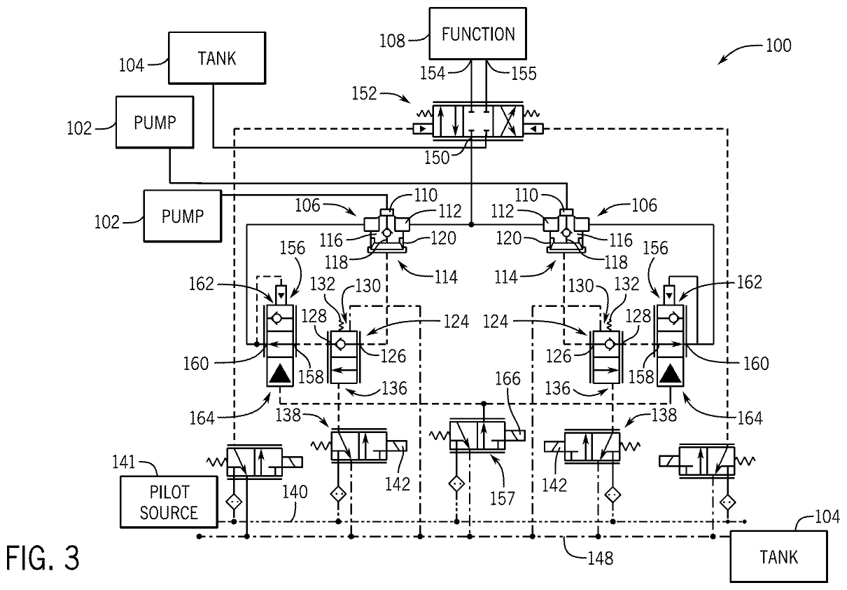

FIG. 3 illustrates another non-limiting example of the hydraulic system 100 according to aspects of the present disclosure. The hydraulic system 100 illustrated in FIG. 3 is similar to the hydraulic system 100 in FIG. 2, with similar components identified using like reference numerals, except as described below or as apparent in the figures. In the illustrated non-limiting example, the hydraulic system 100 includes two pumps 102 supplying two poppet control valves 106. The following description with reference control of one of the poppet control valves 106 and the description similarly applies to the other poppet control valve 106.

In the illustrated non-limiting example, the pilot control valve 124 is a second pilot control valve 124 and the pilot source control valve 138 is a second pilot source control valve 138. The hydraulic system 100 includes a first pilot control valve 156 and a first pilot source control valve 157. The first pilot control valve 156 is arranged between the control chamber 114 and the function workport 112 and the second pilot control valve 124 is arranged in series with the first pilot control valve 156. The first pilot port 126 is in fluid communication with the control chamber 114 and the second pilot port 128 is in fluid communication with a first pilot port 158 of the first pilot control valve 156. A second pilot port 160 of the first pilot control valve 156 is in fluid communication with the function workport 112. In some non-limiting examples, the first pilot control valve 156 may include a poppet or a spool that is movable between any number of positions (e.g., movable in proportion to the forces supplied to each end of the spool or poppet) to vary a restriction between the control chamber 114 and the function workport 112 and control the amount of fluid flow supplied from the inlet workport 110 to the function workport 112.

In the illustrated non-limiting example, the second pilot control valve 124 does not include the pusher rod 134. A first side 162 of the first pilot control valve 156 is supplied with a pressure correlated to the function workport 112, specifically, the pressure in the function workport 112 is supplied to the first side 162 of the first pilot control valve 156. A pilot source pressure is supplied to a second side 164 of the first pilot control valve 156. The pilot source pressure is supplied to the second side 164 of the first pilot control valve 156 by the first pilot source control valve 157. A magnitude of the pilot source pressure supplied to the second side 164 of the first pilot control valve 156 is adjustable by the first pilot source control valve 157, for example, by actuating a solenoid 166 attached to the first pilot source control valve 157. In the illustrated non-limiting example, an area on the first side 162 that is supplied with the pressure in the function workport 112 is smaller than an area of the second side 164 supplied with the pilot source pressure. In this way, for example, the first pilot control valve 156 can be forced to move toward a closed position with a pilot source pressure that is less than the pressure in the function workport 112. The magnitude of the reduced pressure is related to the area ratio between the first side 162 and the second side 164. The area ratio and/or the magnitude of the pilot source pressure can be chosen so that the first pilot control valve 156 moves toward a closed position when the pressure at the function workport 112 reaches the setpoint pressure.

In operation, the pump 102 supplies fluid flow to the inlet workport 110 of one of the poppet control valves 106 and the second pilot source control valve 138 opens to supply the second pilot source pressure to the second side 136 of the second pilot control valve 124. The pressure in the inlet workport 110 increases and moves the poppet 116 from the closed position to the open position where fluid flow is provided to the function workport 112 and to the function 108 (if the directional control valve 152 shifts to allow fluid communication to the function). The pilot source pressure supplied to the second side 136 of the second pilot control valve 124 forces the second pilot control valve 124 toward a second pilot valve open position where fluid communication is provided between the control chamber 114 and the second pilot port 128. If the pressure in the function workport 112 is less than the setpoint pressure, the pilot source pressure supplied to the second side 164 of the first pilot control valve 156 can force the first pilot control valve to an first pilot valve open position where fluid communication is provided between the first pilot port 158 and the second pilot port 160. With the control passage 118 providing fluid communication between the inlet workport 110 (and the function workport 112 when the poppet 116 is in the open position) and the control chamber 114, and the second pilot control valve 124 and the first pilot control valve 156 both allowing fluid communication between the control chamber 114 and the function workport 112, the poppet 116 will move to an open position where the poppet 116 is pressure balanced. That is, the poppet 116 will move to an open position where the forces on both sides of the poppet 116 (i.e., pressure times area) are balanced.

In general, the position of the first pilot control valve 156 between the first pilot valve open position (e.g., valve moves upward from the perspective of FIG. 3) and a first pilot valve closed position (e.g., valve moves downward from the perspective of FIG. 3) controls a restriction between the control chamber 114 and the function workport 112, which influences a position of the poppet 116 between the open position and the closed position and can control an amount of fluid flow supplied to the function 108. During operation of the hydraulic system 100, the pressure at the function workport 112 may fluctuate due to one or more factors (e.g., high function load, pump pressure, initial command to the second pilot control valve 124, etc.). If the pressure in the function workport 112 reaches the setpoint pressure, the pressure in the function workport 112 acting on the first side 162 of the first pilot control valve 156 forces the first pilot control valve 156 toward the first pilot valve closed position and increases a restriction between the control chamber 114 and the function workport 112. The increased restriction between the control chamber 114 and the function workport 112 increases the pressure in the control chamber 114 and forces the poppet 116 to move in a direction toward the closed position. Moving the poppet 116 toward the closed position limits fluid flow to the function 108 thereby limiting the pressure in the function workport 112. In this way, for example, the sense pressure (i.e., the pressure in the function workport 112) acting on the first pilot control valve 156 acts to limit the pressure in the function workport 112 to the setpoint pressure. That is, the sense pressure is correlated to the function workport 112 so that when the workport pressure reaches the setpoint pressure, it is detected by the sense pressure and acts on the first pilot control valve 156 to limit the workport pressure to the setpoint pressure, and prevent the workport pressure from exceeding the setpoint pressure.

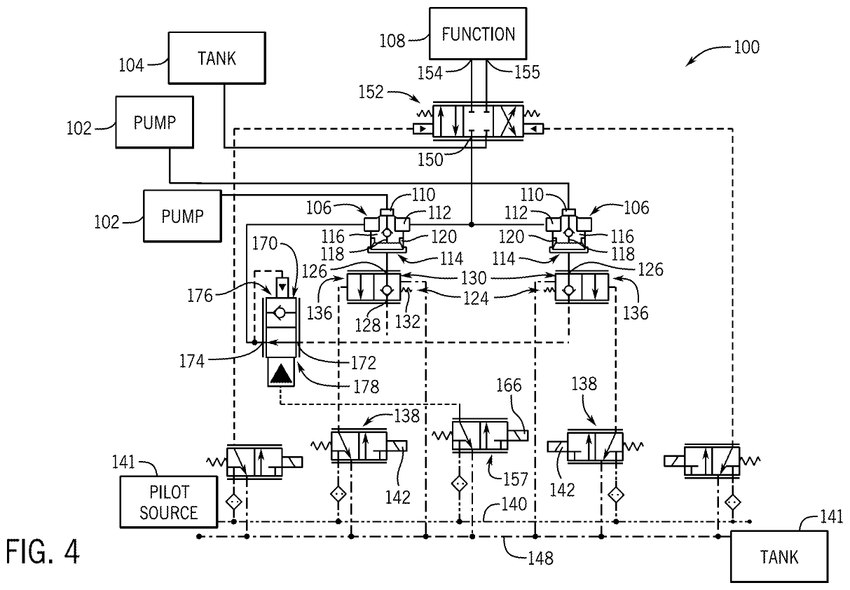

FIG. 4 illustrates another non-limiting example of the hydraulic system 100 according to aspects of the present disclosure. The hydraulic system 100 illustrated in FIG. 4 is similar to the hydraulic system 100 in FIG. 3, with similar components identified using like reference numerals, except as described below or as apparent in the figures. In the illustrated non-limiting example, the functionality provided by the pair of first pilot control valves 156 described with respect to FIG. 3 is integrated into a single valve (i.e., a first pilot control valve 170) in the hydraulic system 100 of FIG. 4. The second pilot ports 128 of both of the second pilot control valve 124 are connected and are in fluid communication with a first pilot port 172 of the first pilot control valve 170. A second pilot port 174 of the first pilot control valve 170 is in fluid communication with the function workports 112.

Like the first pilot control valve 156 described above, a first side 176 of the first pilot control valve 170 is supplied with a pressure correlated to the function workports 112, specifically, the pressure in the function workports 112 is supplied to the first side 176 of the first pilot control valve 170. A pilot source pressure is supplied to a second side 178 of the first pilot control valve 170. The pilot source pressure is supplied to the second side 178 of the first pilot control valve 170 by the first pilot source control valve 157. In the illustrated non-limiting example, an area on the first side 176 that is supplied with the pressure in the function workports 112 is smaller than an area of the second side 178 supplied with the pilot source pressure. In this way, for example, the first pilot control valve 170 can be forced to move toward a closed position with a pilot source pressure that is less than the pressure in the function workports 112. The magnitude of the reduced pressure is related to the area ratio between the first side 176 and the second side 178. The area ratio and/or the magnitude of the pilot source pressure can be chosen so that the first pilot control valve 170 moves toward a closed position when the pressure at the function workports 112 reaches the setpoint pressure.

In general, the position of the first pilot control valve 170 between the first pilot valve open position (e.g., valve moves upward from the perspective of FIG. 4) and a first pilot valve closed position (e.g., valve moves downward from the perspective of FIG. 4) controls a restriction between the control chamber 114 and the function workport 112, which influences a position of the poppets 116 between the open position and the closed position and can control an amount of fluid flow supplied to the function 108. During operation of the hydraulic system 100, the pressure at the function workports 112 may fluctuate due to one or more factors (e.g., high function load, pump pressure, initial command to the second pilot control valve 124, etc.). If the pressure in the function workports 112 reaches the setpoint pressure, the pressure in the function workports 112 acting on the first side 176 of the first pilot control valve 170 forces the first pilot control valve 170 toward the first pilot valve closed position and increases a restriction between the control chambers 114 and the function workports 112. The increased restriction between the control chambers 114 and the function workports 112 increases the pressure in the control chambers 114 and forces the poppets 116 to move in a direction toward the closed position. Moving the poppets 116 toward the closed position limits fluid flow to the function 108 thereby limiting the pressure in the function workports 112. In this way, for example, the sense pressure (i.e., the pressure in the function workports 112) acting on the first pilot control valve 170 acts to limit the pressure in the function workports 112 to the setpoint pressure. That is, the sense pressure is correlated to the function workports 112 so that when the workport pressure reaches the setpoint pressure, it is detected by the sense pressure and acts on the first pilot control valve 170 to limit the workport pressure to the setpoint pressure, and prevent the workport pressure from exceeding the setpoint pressure.

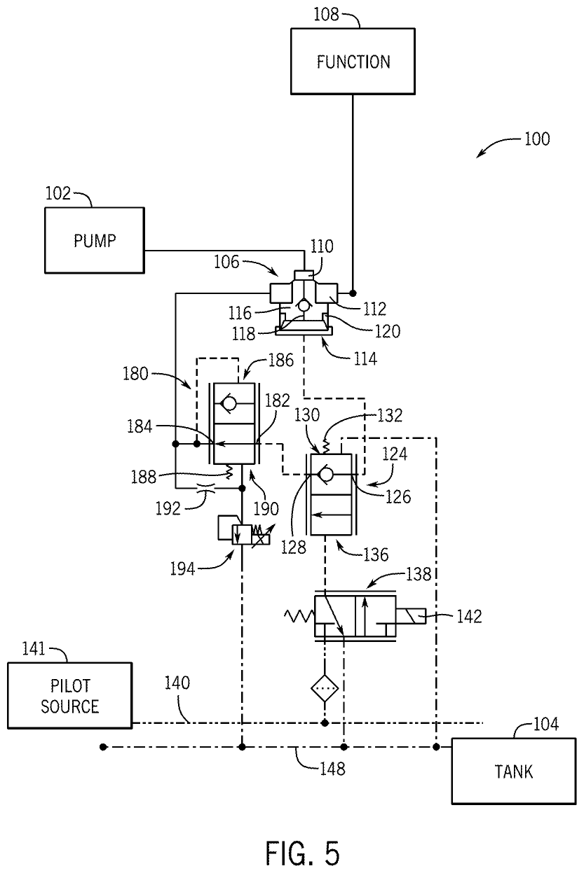

FIG. 5 illustrates another non-limiting example of the hydraulic system 100 according to aspects of the present disclosure. The hydraulic system 100 illustrated in FIG. 5 is similar to the hydraulic system 100 in FIG. 1, with similar components identified using like reference numerals, except as described below or as apparent in the figures. In the illustrated non-limiting example, the pilot control valve 124 is a second pilot control valve 124 and the hydraulic system 100 includes a first pilot control valve 180. The first pilot control valve 180 is arranged between the control chamber 114 and the function workport 112 and the second pilot control valve 124 is arranged in series with the first pilot control valve 180. The first pilot port 126 is in fluid communication with the control chamber 114 and the second pilot port 128 is in fluid communication with a first pilot port 182 of the first pilot control valve 180. A second pilot port 184 of the first pilot control valve 180 is in fluid communication with the function workport 112. In some non-limiting examples, the first pilot control valve 180 may include a poppet or a spool that is movable between any number of positions (e.g., movable in proportion to the forces supplied to each end of the spool or poppet) to vary a restriction between the control chamber 114 and the function workport 112 and control the amount of fluid flow supplied from the inlet workport 110 to the function workport 112.

In the illustrated non-limiting example, the second pilot control valve 124 does not include the pusher rod 134. A first side 186 of the first pilot control valve 180 is supplied with a pressure correlated to the function workport 112, specifically, the pressure in the function workport 112 is supplied to the first side 186 of the first pilot control valve 180. A spring 188 is biased against a second side 190 of the first pilot control valve 180 and a sense pressure is supplied to the second side 190 of the first pilot control valve 180.

A sense orifice 192 in fluid communication with the function workport 112 and a relief valve 194 is arranged downstream of the sense orifice 192. The sense pressure supplied to the second side 190 of the first pilot control valve 180 is located between the sense orifice 192 and the relief valve 194. In general, the relief valve 194 is configured to move between a relief valve closed position, where fluid communication is inhibited past the relief valve 194, to a relief valve open position, where fluid communication is allowed past the relief valve 194. In general, the relief valve 194 is configured to move from the relief valve closed position to the relief valve open position when the pressure in the function workport 112 reaches a setpoint pressure. In the illustrated non-limiting example, the relief valve 194 is an electrohydraulic relief valve with an adjustable-force solenoid (e.g., a proportional solenoid) biasing the relief valve 194 and configured to selectively adjust the setpoint pressure. In some non-limiting examples, the relief valve 194 may include a manually-adjustable setpoint pressure (e.g., an adjustable spring) controlling movement of the relief valve 194 from the relief valve closed position to the relief valve open position.

In general, the position of the first pilot control valve 180 between the first pilot valve open position (e.g., valve moves upward from the perspective of FIG. 5) and a first pilot valve closed position (e.g., valve moves downward from the perspective of FIG. 5) controls a restriction between the control chamber 114 and the function workport 112, which influences a position of the poppet 116 between the open position and the closed position and can control an amount of fluid flow supplied to the function 108. During operation of the hydraulic system 100, the pressure at the function workport 112 may fluctuate due to one or more factors (e.g., high function load, pump pressure, initial command to the second pilot control valve 124, etc.). If the pressure in the function workport 112 reaches the setpoint pressure, the relief valve 194 is configured to move from the relief valve closed position to the relief valve open position, so that the sense pressure between the sense orifice 192 and the relief valve 194 is maintained at the setpoint pressure and the increased pressure in the function workport 112 forces the first pilot control valve 180 toward the first pilot valve closed position and increases the restriction between the control chamber 114 and the function workport 112. The increased restriction between the control chamber 114 and the function workport 112 increases the pressure in the control chamber 114 and forces the poppet 116 to move in a direction toward the closed position. Moving the poppet 116 toward the closed position limits fluid flow to the function 108 thereby limits the pressure in the function workport 112. In this way, for example, the pressure in the function workport 112 acting on the first pilot control valve 180 acts to limit the pressure in the function workport 112 to a combined total pressure that is the sum of the setpoint pressure and the pressure drop across the sense orifice 192. That is, the pressure supplied to the first pilot control valve 180 is correlated to the function workport 112 so that when the workport pressure reaches the setpoint pressure, it acts on the first pilot control valve 180 to limit the workport pressure to the combined total pressure, and prevent the workport pressure from exceeding the combined total pressure.

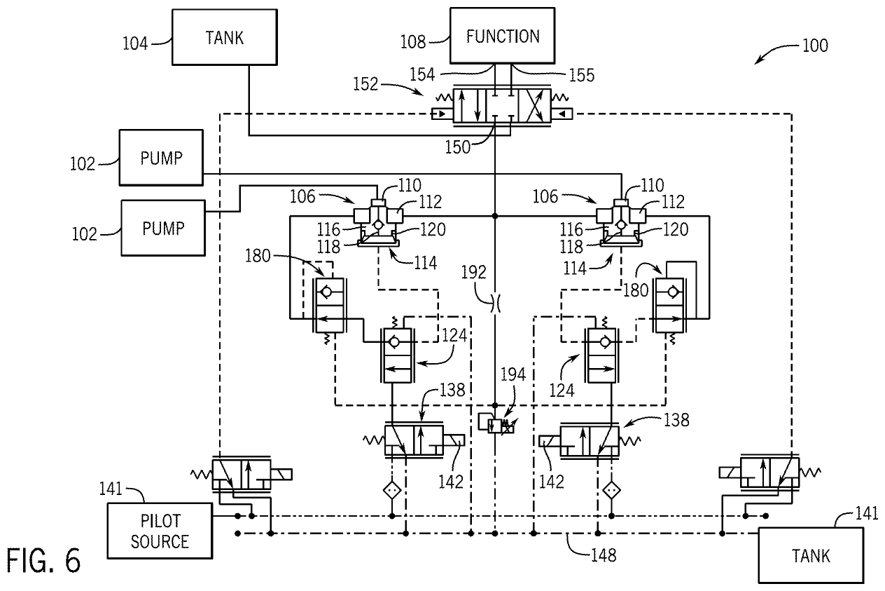

FIG. 6 illustrates the hydraulic system 100 of FIG. 5 being applied to a configuration including two poppet control valves 106 supplying fluid flow to the inlet port 150 on the directional control valve 152. Both of the first pilot control valves 180 are supplied with the pressure between the relief valve 194 and the sense orifice 192, which maintains at least the setpoint pressure on the second sides 190 of the first pilot control valves 180 and allows an increased the pressure in the function workports 112 above the setpoint pressure to force the first pilot control valves 180 toward the first pilot valve closed position. The pressure in the function workports 112 is then limited to the combined total pressure that is the sum of the setpoint pressure and the pressure drop across the sense orifice 192, as described above with respect to FIG. 5.

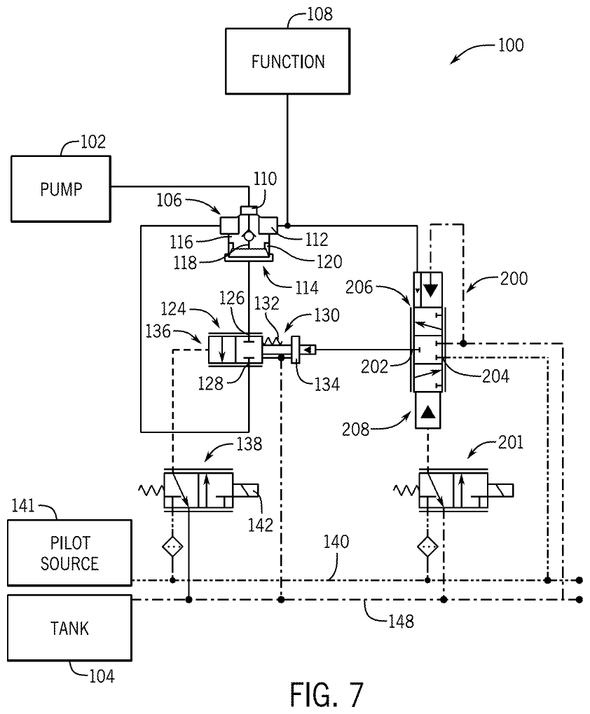

FIG. 7 illustrates another non-limiting example of the hydraulic system 100 according to aspects of the present disclosure. The hydraulic system 100 illustrated in FIG. 7 is similar to the hydraulic system 100 in FIG. 1, with similar components identified using like reference numerals, except as described below or as apparent in the figures. In the illustrated non-limiting example, the pilot control valve 124 is a second pilot control valve 124 and the pilot source control valve 138 is a second pilot source control valve 138. The hydraulic system 100 includes a first pilot control valve 200 and a first pilot source control valve 201. The first pilot control valve 200 includes an outlet port 202 in fluid communication with the first side 130 of the second pilot control valve 124. Specifically, the pressure at the outlet port 202 is supplied to the pusher rod 134. The first pilot control valve includes an inlet port 204 in fluid communication with the pilot conduit 140. A pressure correlated to the function workport 112 is supplied to a first side 206 of the first pilot control valve 200 and acts on a first area. Specifically, the pressure in the function workport 112 is supplied to the first side 206 on the first area. The pilot source pressure is supplied to a second side 208 of the first pilot control valve 200 by the first pilot source control valve 201 and acts on a second area. An area ratio between the first area and the second area balances the pressure correlated to the function workport 112 and the pilot source pressure so that when the pressure in the function workport 112 is greater than the setpoint pressure, the first pilot control valve 200 moves to a position where fluid flow is provided through the outlet port 202 to force the second pilot control valve 124 toward a second pilot valve closed position and increase the flow restriction between the control chamber 114 and the function workport 112. For example, the first pilot control valve 200 is movable from a first pilot valve closed position (center position illustrated in FIG. 7), where fluid communication between the inlet port 204 and the outlet port 202 is inhibited, to a first pilot valve open position (e.g., moving the valve downward from the perspective of FIG. 7), where fluid communication is provided between the inlet port 204 and the outlet port 202. The inlet port 204 is shown connected to a pilot source, but in some non-limiting examples it can be connected to the main pump pressure 102 or the pressure at the function workport 112. The first pilot control valve 200 is movable between the first pilot valve closed position and the first pilot valve open position based on the pressure in the function workport 112.

During operation of the hydraulic system 100, the pressure at the function workport 112 may fluctuate due to one or more factors (e.g., high function load, pump pressure, initial command to the second pilot control valve 124, etc.). If the pressure in the function workport 112 reaches the setpoint pressure (set by the area ratio and the magnitude of the pilot source pressure), the first pilot control valve 200 is forced to move toward the first pilot valve open position and the pilot source pressure is supplied from the inlet port 204 to the outlet port 202 and from the outlet port 202 to the pusher rod 134. The pilot source pressure supplied to the pusher rod 134 forces the second pilot control valve 124 to a position that increases a flow restriction between the control chamber 114 and the function workport 112. In the illustrated non-limiting example, the pilot source pressure acting on the pusher rod 134 forces the second pilot control valve 124 toward a second pilot valve closed position and increases the restriction in the flow path between the control chamber 114 and the function workport 112. The increased restriction between the control chamber 114 and the function workport 112 increases the pressure in the control chamber 114 and forces the poppet 116 to move in a direction toward the closed position. Moving the poppet 116 toward the closed position limits fluid flow to the function 108 thereby limiting the pressure in the function workport 112. In this way, for example, the sense pressure acting on the first pilot control valve 200 acts to limit the pressure in the function workport 112 to the setpoint pressure. That is, the sense pressure is correlated to the function workport 112 so that when the workport pressure reaches the setpoint pressure, it is detected by the sense pressure and acts on the first pilot control valve 200 to limit the workport pressure to the setpoint pressure, and prevent the workport pressure from exceeding the setpoint pressure.

Within this specification embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein.

Thus, while the invention has been described in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein.

Various features and advantages of the invention are set forth in the following claims.

1. A hydraulic system for controlling a flow of fluid to a function, the hydraulic system comprising:
a poppet control valve including an inlet workport, a function workport, a control chamber, and a poppet arranged between the inlet workport and the control chamber, the poppet being movable between an open position and a closed position; and
a pilot control valve, wherein a pressure correlated to the function workport is supplied to a first side of the pilot control valve and a pilot source pressure is supplied to a second side of the pilot control valve,
wherein when a pressure in the function workport reaches a setpoint pressure, the pressure correlated to the function workport forces the pilot control valve to a position that increases a flow restriction between the control chamber and the function workport, so that the poppet moves in a direction toward the closed position and limits the pressure in the function workport to the setpoint pressure.

2. The hydraulic system of claim 1, wherein the poppet includes a control passage providing fluid communication between the inlet workport and the control chamber, and wherein the poppet defines a variable orifice that defines an increasing flow area along the control passage as the poppet moves from the closed position toward the open position.

3. The hydraulic system of claim 1, further comprising a relief valve arranged downstream of the function workport.

4. The hydraulic system of claim 3, further comprising a sense orifice arranged downstream of the relief valve.

5. The hydraulic system of claim 4, wherein the pressure correlated to the function workport supplied to the first side of the pilot control valve is located between the relief valve and the sense orifice.

6. The hydraulic system of claim 5, wherein when the pressure in the function workport reaches the setpoint pressure, the relief valve is configured to move from a relief valve closed position to a relief valve open position, so that the pressure located between the relief valve and the sense orifice increases.

7. The hydraulic system of claim 6, wherein the increasing pressure located between the relief valve and the sense orifice forces the pilot control valve to move toward a pilot valve closed position so that the poppet moves toward the closed position.

8. The hydraulic system of claim 7, wherein the pressure located between the relief valve and the sense orifice is supplied to a pusher rod in engagement with the first side of the pilot control valve.

9. (canceled)

10. (canceled)

11. The hydraulic system of claim 1, wherein the pilot control valve is a first pilot control valve and the hydraulic system further comprises a second pilot control valve.

12. The hydraulic system of claim 11, wherein the first pilot control valve includes an outlet port in fluid communication with a first side of the second pilot control valve.

13. The hydraulic system of claim 12, wherein the pressure correlated to the function workport supplied to the first side of the first pilot control valve acts on a first area, and the pilot source pressure supplied to the second side of the first pilot control valve acts on a second area.

14. The hydraulic system of claim 13, wherein an area ratio between the first area and the second area balances the pressure correlated to the function workport and the pilot source pressure so that when the pressure in the function workport reaches a setpoint pressure, the first pilot control valve moves to a position where fluid flow is provided through the outlet port to force the second pilot control valve toward a second pilot valve closed position and increase the flow restriction between the control chamber and the function workport.

15. A hydraulic system for controlling a flow of fluid to a function, the hydraulic system comprising:
a poppet control valve including an inlet workport, a function workport, a control chamber, and a poppet arranged between the inlet workport and the control chamber, wherein the poppet includes a variable orifice that defines an increasing flow area in the control chamber as the poppet moves from a closed position toward an open position;
a pilot control valve arranged between the control chamber and the function workport, wherein a pusher rod is in engagement with a first side of the pilot control valve and a pilot source pressure is supplied to a second side of the pilot control valve;
a relief valve arranged downstream of the function workport; and
a sense orifice arranged downstream of the relief valve, wherein a sense pressure between the relief valve and the sense orifice is supplied to the pusher rod, wherein when a pressure in the function workport reaches a setpoint pressure, the relief valve is configured to move from a relief valve closed position to a relief valve open position, so that the sense pressure increases and forces the pusher rod to move the pilot control valve toward a pilot valve closed position and the poppet moves in a direction toward the closed position to limit the pressure in the function workport to the setpoint pressure.

16. The hydraulic system of claim 15, wherein an area defined by a side of the pusher rod supplied with the sense pressure is larger than an area of the second side of the pilot control valve.

17. The hydraulic system of claim 15, wherein the relief valve is an electrohydraulic relief valve.

18. (canceled)

19. (canceled)

20. The hydraulic system of claim 15, wherein the poppet includes a control passage providing fluid communication between the inlet workport and the control chamber.

21. A hydraulic system for controlling a flow of fluid to a function, the hydraulic system comprising:
a poppet control valve including an inlet workport, a function workport, a control chamber, and a poppet arranged between the inlet workport and the control chamber, wherein the poppet includes a variable orifice that defines an increasing flow area in the control chamber as the poppet moves from a closed position toward an open position; and
a first pilot control valve arranged between the control chamber and the function workport;
a second pilot control valve arranged in series with the first pilot control valve, wherein a spring is in engagement with a first side of the second pilot control valve and a pilot source pressure is supplied to a second side of the second pilot control valve, wherein when a pressure in the function workport reaches a setpoint pressure, the first pilot control valve is configured to move toward a first pilot valve closed position to increase a restriction between the control chamber and the function workport, so that the poppet moves in a direction toward the closed position and limits the pressure in the function workport to the setpoint pressure.

22. The hydraulic system of claim 21, wherein a pressure in the function workport is supplied to a first side of the first pilot control valve.

23. The hydraulic system of claim 22, wherein the pilot source pressure is supplied to the second side of the first pilot control valve.

24. The hydraulic system of claim 23, wherein a magnitude of the pilot source pressure supplied to the second side of the first pilot control valve is adjustable by a first pilot source control valve.

25. The hydraulic system of claim 23, wherein an area of the first side of the first pilot control valve supplied with the pressure in the function workport is smaller than an area of the second side of the first pilot control valve supplied with the pilot source pressure.

26. The hydraulic system of claim 21, wherein the poppet includes a control passage providing fluid communication between the inlet workport and the control chamber.

27. The hydraulic system of claim 21, further comprising a sense orifice in fluid communication with the function workport, and a relief valve arranged downstream of the sense orifice,
wherein a pressure in the function workport is supplied to a first side of the first pilot control valve, and a pressure located between the sense orifice and the relief valve is supplied to a second side of the first pilot control valve.

28. (canceled)

29. (canceled)

30. The hydraulic system of claim 29, wherein when the pressure in the function workport reaches the setpoint pressure, the relief valve is configured to move from a relief valve closed position to a relief valve open position, so that the pressure between the sense orifice and the relief valve is maintained at the setpoint pressure and the increased pressure in the function workport forces the first pilot control valve toward a first pilot valve closed position.
